(19) United States
(12) Patent Application Publication
(10) Pub. No.: US 2026/0153626 A1
(43) Pub. Date: Jun. 4, 2026

(54) METHOD AND SYSTEM FOR VEHICLE PLACE RECOGNITION

(71) Applicant: CHANG'AN UNIVERSITY, Xi'an (CN)

(72) Inventors: Xiangmo ZHAO, Xi'an (CN); Wuqi WANG, Xi'an (CN); Haigen MIN, Xi'an (CN); Xia WU, Xi'an (CN); Zhigang XU, Xi'an (CN); Xuming SHANG, Xi'an (CN); Zhanwen LIU, Xi'an (CN); Runmin WANG, Xi'an (CN); Yanbing YAN, Xi'an (CN); Yukun FANG, Xi'an (CN); Wenjing WANG, Xi'an (CN); Sen XIA, Xi'an (CN); Xiaoping LEI, Xi'an (CN); Yao LI, Xi'an (CN); Changlei YAN, Xi'an (CN); Long YANG, Xi'an (CN)

(21) Appl. No.: 19/463,022

(22) Filed: Jan. 28, 2026

Related U.S. Application Data
(63) Continuation of application No. PCT/CN2024/144416, filed on Dec. 31, 2024.

(51) Int. Cl. G01S 17/89

(52) U.S. Cl. CPC G01S 17/89

(57) ABSTRACT

A method for vehicle place recognition, in which LiDAR data of a vehicle is processed to obtain a point cloud result of a vehicle LiDAR. An environmental descriptor is constructed based on the point cloud result. Based on a type of a LiDAR sensor of the LiDAR data and a measurement environment, a dynamic filtering strategy threshold is calculated. Compared the environmental descriptor and the dynamic filtering strategy threshold with point cloud data in a historical database, a vehicle position information is obtained.

### CROSS-REFERENCE TO RELATED APPLICATIONS

This application is a continuation of International Patent Application No. PCT/CN2024/144416, filed on Dec. 31, 2024, which claims the benefit of priority from Chinese Patent Application No. 202311437884.2, filed on Oct. 31, 2023. The content of the aforementioned application, including any intervening amendments thereto, is incorporated herein by reference in its entirety.

### TECHNICAL FIELD

This application relates to high-precision vehicle location technologies, and more particularly to a method and system for vehicle place recognition.

### BACKGROUND

Intelligent robots and autonomous vehicles integrate a variety of complex emerging technologies, showing significant practical value in current and future transportation fields, where accurate, continuous and stable position information is crucial for robots or autonomous vehicles. Although the position information can be obtained through global navigation satellite systems, obtained location information often contains various errors due to environmental complexity of urban environment. Simultaneous localization and mapping is adopted to solve problems of localization, navigation, and map construction for mobile vehicles or autonomous vehicles of robots in unknown environments, having relatively high robustness in complex scenarios.

The accuracy of a position method based on map matching is directly related to the accuracy of map construction. Higher-accuracy position information is obtained by matching with a preloaded map. During the map construction process, drift is inevitable and typically affects the estimated state of trajectories, however, the impact of the drift can be effectively eliminated by revisiting the same location multiple times to create a map with higher consistency. The place recognition, also known as loop closure detection in map construction, is crucial for recognizing and returning to the same position. A plurality of vision-based place recognition methods already exist and have demonstrated their utility in practical applications. However, changes in viewpoint and light intensity may lead to detection failures. In contrast, LiDAR, as an active sensor, is easier to play a role in place recognition. Existing LiDAR-based recognition methods can be classified into direct methods and descriptor-based methods. The direct methods directly use LiDAR point cloud data for matching, however, since raw LiDAR data often contains various errors, recognition performance inevitably degrades. The descriptor-based methods are further divided into local descriptors and global descriptors. These two types of descriptors differ in the amount of point cloud information they utilize, maintain performance under various changes, and exhibit high applicability in sampling and noise resistance. However, traditional descriptors merely represent environmental information in a simplistic manner and overlook some intrinsic properties of the point cloud, and it is hard to handle situations where revisit the same location including offset or rotation, such as changes in azimuth or roll angle. In addition, recognition efficiency is also one of critical problems in place recognition. Traditional detection methods rely on brute-force matching that utilizing descriptors, which undoubtedly consumes significant time and hardly meets practical requirements of engineering applications.

### SUMMARY

This application provides a method and system for vehicle place recognition to overcome problems of low efficiency of traditional LiDAR place recognition and low identification accuracy in complex revisit environments.

The method for vehicle place recognition, comprising:
(S1) preprocessing light detection and ranging (LiDAR) data of a vehicle to obtain a LiDAR point cloud result of the vehicle;
(S2) constructing an environmental descriptor based on the LiDAR point cloud result;
(S3) based on a type of a LiDAR sensor for collecting the LiDAR data of the vehicle and a measurement environment, calculating a threshold of a dynamic filtering strategy; and
(S4) according to the threshold of the dynamic filtering strategy, comparing the environmental descriptor with point cloud data in a historical database to obtain a position information of the vehicle.

In an embodiment, step of preprocessing the LiDAR data of the vehicle to obtain the LiDAR point cloud result comprises:
downsampling the LiDAR data of the vehicle to generate a downsampled LiDAR data;
filtering out a data within a preset range around the LiDAR sensor for obtaining the LiDAR data from the downsampled LiDAR data; and
based on a traveling speed of the vehicle, performing a de-distortion operation on a laser scanning to obtain the LiDAR point cloud result of the vehicle.

In an embodiment, the method further comprises:
downsampling a point cloud in the LiDAR data of the vehicle through using a point cloud voxel filter in a point cloud library (PCL), expressed as:

$$SetInputCloud ( source\_cloud ) ; \qquad ( 1 )$$

$$SetLeafSize ( x\_size , y\_size , z\_size ) ; and \qquad ( 2 )$$

$$Filter {(}^{*} dest\_cloud ) ; \qquad ( 3 )$$

wherein source_cloud represents an original point cloud data in the LiDAR data; dest_cloud represents the downsampled point cloud data; and SetInputCloud(•) SetLeafSize(•) and Filter(•) are functions related to point cloud downsampling in the PCL.

In an embodiment, the step of filtering out the data within the preset range around the LiDAR sensor for obtaining the LiDAR data from the downsampled LiDAR data comprises:
for each laser point in a laser scanning range of the LiDAR sensor, removing laser points whose Euclidean distances are lower than a preset threshold, expressed as:

$$\{ \begin{matrix}\sqrt{( {x}_{i}^{2} + {y}_{i}^{2} )} \leq δ s & filter out \\ \sqrt{( {x}_{i}^{2} + {y}_{i}^{2} )} \begin{matrix}> \\ \neq \end{matrix} δ s & retain\end{matrix} ; \qquad ( 4 )$$

wherein xᵢ and yᵢ respectively represent x-coordinate and y-coordinate of an i-th laser point in a laser scanning frame; and through this step, the laser point within the preset range around the LiDAR sensor are removed.

In an embodiment, the method further comprises:
removing a distorted data, expressed as:

$$realTime = \frac{1}{{H}_{z}} * arctan ( \frac{y}{x} ) / 360 ; and \qquad ( 5 )$$

$$[ {x}_{i} , {y}_{i} , {z}_{i} ] = [ {x}_{i} , {y}_{i} , {z}_{i} ] * T * realTime + [ {x}_{i} , {y}_{i} , {z}_{i} ] * realTime ; \qquad ( 6 )$$

wherein realTime represents a relative time of each laser point within a scan frame, and T represents a motion estimation of the vehicle at a current moment.

In an embodiment, step (S2) comprises:
determining whether each laser point in the LiDAR point cloud result is a ground point or a non-ground point by using g(•), expressed as:

$$ℊ ( x , y , z ) = \{ \begin{matrix}1 & ground point \\ 0 & non - ground point\end{matrix} ; \qquad ( 7 )$$

converting all laser points in the LiDAR point cloud result into a polar coordinate system, expressed as:

$$d = \sqrt{{x}^{2} + {y}^{2}} ; and \qquad ( 8 )$$

$$θ = arctan 2 ( \frac{y}{x} ) ; \qquad ( 9 )$$

wherein d represents a horizontal distance from a laser point to the LiDAR sensor, and θ represents an angle between the laser point and a polar axis;
from in a bird's-eye view, dividing a lateral direction into Nr parts based on distance, and dividing a longitudinal direction into Ns parts based on angle;
constructing a Nr*Ns matrix corresponding to each Nr*Ns parts;
according to a height information of a ground point and an intensity information of a non-ground point, assigning a value to each unit of the Nr*Ns matrix:

$$Q ( i , j ) = {Z ( i , j )}_{max}^{1 - g} * {I ( i , j )}_{max}^{g} ; \qquad ( 10 )$$

wherein Q(i,j) represents the value of each unit, Z(i,j) represents a maximum height z in a corresponding space, and I(i,j) represents a maximum intensity in the corresponding space; and
assigning values to matrices respectively corresponding to individual spaces to construct a point cloud descriptor.

In an embodiment, the method further comprises:
denoting an F-norm difference between two descriptors in any two LiDAR measurements as:

$$Ψ ( i , j ) = \frac{abs ( {F}_{i} - {F}_{j} )}{{F}_{i}} ; \qquad ( 11 )$$

wherein Fᵢ and Fⱼ represent F-norms of two descriptors constructed in two separate LiDAR measurements, respectively;
setting a dynamic threshold to be:

$$Φ ( i ) = \frac{abs ( \sqrt{{\sum }_{k = 1}^{n} ( {d}_{k}^{2} + {z}_{k}^{2} )} - \sqrt{{\sum }_{i = 1}^{n} {( {d}_{k} + Δ {ρ}_{k} )}^{2} + {z}_{k}^{2}} )}{\sqrt{{\sum }_{k = 1}^{n} ( {d}_{k}^{2} + {z}_{k}^{2} )}} ; \qquad ( 12 )$$

wherein Δρₖ represents a translation value;
simplifying the dynamic threshold into formula (13) by denoting a maximum Δρ as Δμₘₐₓ and taking z and d as average values of general measurements of the LiDAR sensor:

$$Φ ( i ) = \sqrt{1 + \frac{{2}^{*} {\overline{d}}^{*} Δ {ρ}_{max} + Δ {ρ}_{max}^{2}}{{\overline{d}}^{2} + {\overline{z}}^{2}}} - 1 ; \qquad ( 13 )$$

comparing Ψ(•) with Φ(•) to determine whether two LiDAR measurements are performed at the same position.

This application also provides a system for vehicle place recognition, comprising:
a data acquisition and processing module;
a descriptor construction module;
a threshold calculation module; and
a place recognition module;
wherein the data acquisition and processing module is configured to preprocess the LiDAR data of the vehicle to obtain the LiDAR point cloud result of the vehicle;
the descriptor construction module is configured to construct the environmental descriptor based on the LiDAR point cloud result;
the threshold calculation module is configured to calculate the threshold of the dynamic filtering strategy based on the type of the LiDAR sensor for collecting the LiDAR data of the vehicle and the measurement environment;
the place recognition module is configured to compare the environmental descriptor with point cloud data in a historical database according to the threshold of the dynamic filtering strategy, to obtain a position information of the vehicle.

In an embodiment, the data acquisition and processing module is configured to downsample the LiDAR data of the vehicle to generate a downsampled LiDAR data;
filter out a data within a preset range around the LiDAR sensor for obtaining the LiDAR data from the downsampled LiDAR data; and
based on a traveling speed of the vehicle, perform a de-distortion operation on a laser scanning to obtain the LiDAR point cloud result of the vehicle.

In an embodiment, the data acquisition and processing module is also configured to downsample a point cloud in the LiDAR data of the vehicle by using a point cloud voxel filter in a point cloud library (PCL), expressed as:

$$SetInputCloud ( source\_cloud ) ; \qquad ( 1 )$$

$$SetLeafSize ( x\_size , y\_size , z\_size ) ; and \qquad ( 2 )$$

$$Filter \text{(*} dest\_cloud ) ; \qquad ( 3 )$$

wherein source_cloud represents an original point cloud data in the LiDAR data; dest_cloud represents a downsampled point cloud data; and SetInputCloud(•) SetLeafSize(•) and Filter(•) are functions related to point cloud downsampling in the PCL.

Compared to the prior art, this application has the following beneficial effects.

The method for vehicle place recognition provided herein obtains the LiDAR point cloud result of the vehicle through preprocessing LiDAR data of the vehicle, constructs the environmental descriptor based on the LiDAR point cloud result, calculates the threshold of the dynamic filtering strategy based on the type of the LiDAR sensor for collecting the LiDAR data and the measurement environment, and obtains the vehicle position information through comparing the environmental descriptor with point cloud data in the historical database according to the threshold of the dynamic filtering strategy. The present disclosure improves the accuracy and efficiency of place recognition. The present disclosure considers angle resolution ratios and measurement ranges of different LiDARs, and proposes the threshold of the dynamic filtering strategy, enhancing the generalization capability of the method for various sensor models.

Preferably, the present disclosure considers rotational changes during revisit and use of different sensor models, and is added into map construction through utilizing graph optimization, so as to enhance map consistency. The present disclosure divides the ground point and the non-ground point from LiDAR measurements, and constructs descriptors through fusing the height information of the ground point with the intensity information of the non-ground point, which significantly improves the environmental characterization capability of the descriptors.

### BRIEF DESCRIPTION OF THE DRAWINGS

FIG. 1 is a flow chart of a method for vehicle place recognition according to an embodiment of the present disclosure.

FIG. 2 is a flow chart of point cloud preprocessing according to an embodiment of the present disclosure.

FIG. 3 is a schematic diagram of point cloud descriptor segmentation according to an embodiment of the present disclosure.

FIG. 4 is a schematic diagram of point cloud descriptors according to an embodiment of the present disclosure.

### DETAILED DESCRIPTION OF EMBODIMENTS

In order to make those of ordinary skill in the art better understand this application, the technical solutions of the embodiments of the present disclosure will be clearly and completely described with reference to the accompanying drawings of the embodiments of the present disclosure. It is obvious that described herein are only some embodiments of the present disclosure, rather than all embodiments. Based on the embodiments of the present disclosure, other embodiments obtained by those of ordinary skill in the art without making creative effort shall fall within the scope of the present disclosure.

It should be noted that the terms “first” and “second” are used for distinguishing similar objects, rather than describing a specific sequence or order of precedence It should be understood that the data used in this way can be interchanged where appropriate, such that the embodiments of the present disclosure described here can be implemented in orders other than those illustrated or described herein. In addition, the terms “comprising”, “having”, and any variations thereof, are intended to cover a non-exclusive inclusion. For example, a process, method, system, product, or device that comprises a series of steps or units are not necessarily limited to those expressly listed steps or units, but may include other steps or units not expressly listed or inherent to such process, method, product, or device.

The present disclosure provides a method for vehicle place recognition, including the following steps.

(S1) Light detection and ranging (LiDAR) data of a vehicle is processed to obtain a LiDAR point cloud result of the vehicle.

(S2) An environmental descriptor is constructed based on the LiDAR point cloud result.

(S3) Based on a type of a LiDAR sensor for collecting the LiDAR data of the vehicle and a measurement environment, a threshold of a dynamic filtering strategy is calculated.

(S4) According to the threshold of the dynamic filtering strategy, the environmental descriptor is compared with point cloud data in a historical database to obtain a position information of the vehicle.

In an embodiment, the present disclosure further provides a system for vehicle place recognition. The system includes a data acquisition platform equipped with the LiDAR sensor and a data processing and computation platform. The data acquisition platform is configured to acquire environmental information for map construction. The data processing and computation platform is configured to construct the environmental descriptor and perform place recognition.

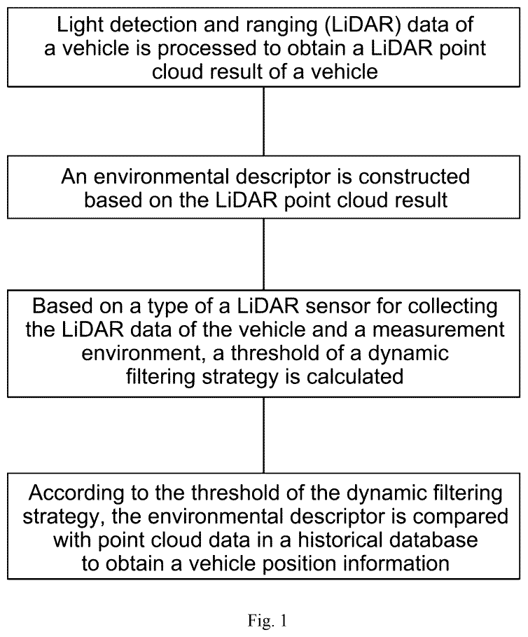

The data acquisition platform includes the LiDAR arranged on the vehicle, and a mounting position of the LiDAR is shown in FIG. 1, which is horizontally mounted on a roof of the vehicle. The present disclosure utilizes an RS-Ruby 128 LiDAR, which has 128 laser channels with a non-linear distribution. The RS-Ruby 128 LiDAR has a longitudinal observation angle within −25°-+15° and has a minimum angle resolution of 0.1°.

The data processing and computation platform is an industrial computer equipped on the vehicle, which is connected to the LiDAR via a network cable, and is configured to collect and process the environmental information acquired by the LiDAR in real time.

The step of LiDAR data of the vehicle is processed to obtain the LiDAR point cloud result of the vehicle includes the following steps.

A measurement information of an original point cloud data of the vehicle has significant errors due to vehicle's motion, and an excessively large number of laser points, which makes it difficult to process and calculate.

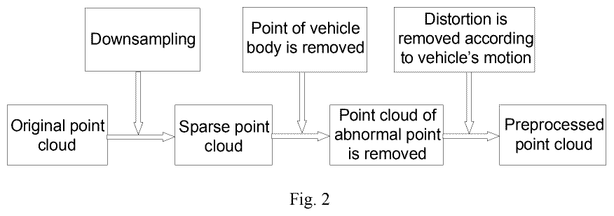

Referring to FIG. 2, before the environmental descriptor is constructed, the present disclosure needs to preprocess the LiDAR data of the vehicle. The present disclosure corrects the LiDAR data of the vehicle in three aspects, specifically described as follows. The LiDAR data of the vehicle is downsampled to generate a downsampled LiDAR data to ensure the processing efficiency of subsequent steps. Then the downsampled LiDAR data is filtered to obtain a data within a preset range around the LiDAR sensor, so as to prevent interference in subsequent detection. Finally, a de-distortion operation is performed on a laser scanning based on a traveling speed of the vehicle, so as to improve the accuracy of obtained laser scanning.

Specific steps are described as follows.

(S1-1) A point cloud in the LiDAR data of the vehicle is downsampled by using a point cloud voxel filter in a point cloud library (PCL), expressed as:

$$SetInputCloud ( source\_cloud ) ; \qquad ( 1 )$$

$$SetLeafSize ( x\_size , y\_size , z\_size ) ; and \qquad ( 2 )$$

$$Filter \text{(*} dest\_cloud ) ; \qquad ( 3 )$$

where source_cloud represents an original point cloud data in the LiDAR data; dest_cloud represents a downsampled point cloud data; and SetInputCloud(•) SetLeafSize(•) and Filter (•) are functions related to point cloud downsampling in the PCL.

(S1-2) The data within the preset range around the LiDAR sensor for obtaining the LiDAR data from the downsampled LiDAR data is filtered.

When the LiDAR sensor is mounted on the vehicle, its vehicle body would be captured as part of the environmental information, which is easy to reduce the environmental characterization capability. Therefore, for each laser point in the laser scanning of the LiDAR sensor, a laser point whose Euclidean distance is set in a set threshold is removed:

$$\{ \begin{matrix}\sqrt{( {x}_{i}^{2} + {y}_{i}^{2} )} \leq δ s & filter out \\ \sqrt{( {x}_{i}^{2} + {y}_{i}^{2} )} \begin{matrix}> \\ \neq \end{matrix} δ s & retain\end{matrix} ; \qquad ( 4 )$$

where xᵢ and yᵢ respectively represent x-coordinate and y-coordinate of an i-th laser point in a laser scanning frame; and through this step, the laser point within the preset range of δs around the LiDAR sensor are removed.

(S1-3) A distorted data is removed.

Distortion is removed in the laser scanning using a vehicle's motion state. When the vehicle is moving, the LiDAR sensor collects the environmental information, and collected laser points exhibit varying degrees of distortion due to the traveling speed and rotation. Therefore, the distorted data is needed to be removed, expressed as:

$$realTime = \frac{1}{{H}_{z}} * arctan ( \frac{y}{x} ) / 360 ; and \qquad ( 5 )$$

$$[ {x}_{i} , {y}_{i} , {z}_{i} ] = [ {x}_{i} , {y}_{i} , {z}_{i} ] * T * realTime + [ {x}_{i} , {y}_{i} , {z}_{i} ] * realTime ; \qquad ( 6 )$$

where realTime represents a relative time of each laser point within a scan frame, and T represents a motion estimation of the vehicle at a current moment.

The environmental descriptor is constructed through utilizing the LiDAR point cloud result.

Based on step (S1), the data within the preset range around the LiDAR sensor is removed, and a distorted sparse point cloud result is corrected. In this step, such LiDAR point cloud result is utilized to construct the environmental descriptor. First, whether each laser point in the LiDAR point cloud result is a ground point or a non-ground point is determined by using (•), expressed as:

$$ℊ ( x , y , z ) = \{ \begin{matrix}1 & ground point \\ 0 & non - ground point\end{matrix} . \qquad ( 7 )$$

All laser points in the LiDAR point cloud result are converted into a polar coordinate system, expressed as:

$$d = \sqrt{{x}^{2} + {y}^{2}} ; and \qquad ( 8 )$$

$$θ = arctan 2 ( \frac{y}{x} ) ; \qquad ( 9 )$$

where d represents a horizontal distance from a laser point to the LiDAR sensor, and θ represents an angle between the laser point and a polar axis (positive half of an original X-axis).

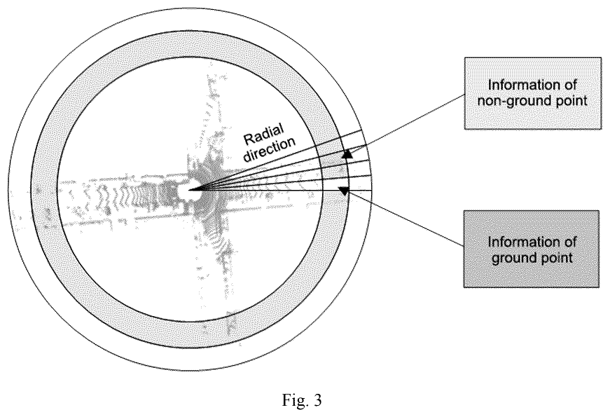

From a bird's-eye view, a lateral direction is divided into Nr parts based on distance, and a longitudinal direction is divided into Ns parts based on angle as shown in FIG. 3. A Nr*Ns matrix is constructed corresponding to Nr*Ns parts. According to a height information of a ground point and an intensity information of a non-ground point, a value on each unit of the Nr*Ns matrix is assigned as:

$$Q ( i , j ) = {Z ( i , j )}_{max}^{1 - g} * {I ( i , j )}_{max}^{g} ; \qquad ( 10 )$$

where Q(i,j) represents the value of each unit, Z(i,j) represents a maximum height z in a corresponding space, and I(i,j) represents a maximum intensity in the corresponding space

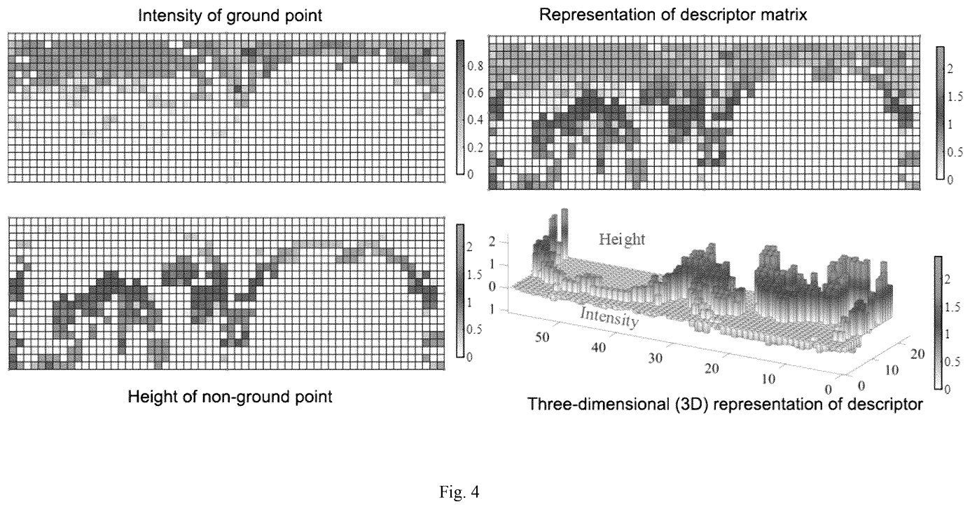

Values to matrices are assigned respectively corresponding to individual spaces to construct a point cloud descriptor. FIG. 4 shows a constructed point cloud descriptor.

The step of based on the type of the LiDAR sensor for collecting the LiDAR data of the vehicle and the measurement environment, the threshold of the dynamic filtering strategy is calculated is performed through the following steps.

In the above steps, the environmental descriptor has been constructed to compactly represent the LiDAR measurements. For two separate visits to the same position, two measurement results should be essentially identical, and F-norms of the constructed descriptors should be equal. However, during actual revisit, rotational and slight offsets exist, which cannot ensure identical descriptors. Therefore, an F-norm difference between two descriptors in any two instances is denoted as:

$$Ψ ( i , j ) = \frac{abs ( {F}_{i} - {F}_{j} )}{{F}_{i}} ; \qquad ( 11 )$$

where Fᵢ and Fⱼ represent F-norms of two descriptors constructed in two separate LiDAR measurements, respectively.

For the visit to the same position, the F-norms exhibit rotational invariance, resulting in a small difference. For the revisits to different positions, the obtained F-norm difference is large, which allows rapid determination of whether the visits are to the same position. However, in practical applications, considering that the F-norms lack translational invariance and the measurement ranges of sensors vary, the present disclosure designs a dynamic threshold related to the sensor itself as:

$$Φ ( i ) = \frac{abs ( \sqrt{{\sum }_{k = 1}^{n} ( {d}_{k}^{2} + {z}_{k}^{2} )} - \sqrt{{\sum }_{i = 1}^{n} {( {d}_{k} + Δ {ρ}_{k} )}^{2} + {z}_{k}^{2}} )}{\sqrt{{\sum }_{k = 1}^{n} ( {d}_{k}^{2} + {z}_{k}^{2} )}} ; \qquad ( 12 )$$

where Δρₖ represents a translation value.

The dynamic threshold is simplified into formula (13) by denoting a maximum Δρ as Δβₘₐₓ and taking z and d as average values of general measurements of the LiDAR sensor as:

$$Φ ( i ) = \sqrt{1 + \frac{2 * \overline{d} * {Δρ}_{max} + Δ {ρ}_{max}^{2}}{{\overline{d}}^{2} + {\overline{z}}^{2}}} - 1. \qquad ( 13 )$$

Ψ(•) and Φ(•) are compared to determine whether the two LiDAR measurements are performed at the same position.

A process of vehicle place recognition is described as follows.

For a laser scanning P_{L} at a certain position L, a point cloud with the same position from the historical point cloud data of the vehicle is identified as a place recognition. Since the number of historical point clouds will continuously increase with operation time, the method of the present disclosure provides a coarse-to-fine hierarchical identification strategy.

### (S4-1) Rapid Retrieving

For any frame of historical scanning, the constructed environmental descriptor is utilized, and an average value of row vectors of each matrix is calculated to obtain an Nr-dimensional vector. K historical point clouds with the highest similarity ranking with the current scanning vector are quickly retrieved through KD-Tree, and these historical point clouds are called initial candidates.

### (S4-2) F-Norm Filtering

The F-norm difference between the current point cloud and the K initial candidates obtained in step (S4-1) is calculated. Based on the dynamic filtering strategy threshold obtained above, a quantitative relationship between Ψ(•) and Φ(•) is compared, and candidates that in accord with Ψ(•)≤Φ(•) are remained, thereby reducing the number of candidates and improving the accuracy and efficiency of place recognition.

### (S4-3) Precise Matching

After F-norm filtering in step (S4-2), the remaining candidates are finally determined through precise matching whether they are the same position measurement as the current point cloud. By using the environmental descriptor constructed in step (S2), differences between the remaining candidates and the current point cloud environmental descriptor are calculated. The vector distance between the two descriptor matrices is calculated column by column as the difference of the descriptors. The matrix Aᵢⱼ (i≤Ns, j≤Nr) of this method corresponding to the current candidate is denoted as, and the vector distance corresponding to the candidate is denoted as Bᵢⱼ (i≤Ns, j≤Nr)

$$d i s ( A , B ) = {\sum }_{j = 1}^{N s} ( \frac{( {A}_{\cdot j} , {B}_{\cdot j} )}{\sqrt{\vert {A}_{\cdot j} \vert + \vert {B}_{\cdot j} \vert}} * \frac{1}{N s} ) . \qquad ( 14 )$$

However, in actual application, there may be changes in azimuths of two candidates. In order to eliminate influence brought by changes of the azimuths, this method calculates the differences between the two descriptors multiple times through rotating the descriptors, and takes a smallest calculation result as a final difference between the two descriptors:

$$D i s ( A , B ) = {min}_{shift = 1}^{N s} ( d i s ( A , B ) ) . \qquad ( 15 )$$

The final difference Dis(A,B) is compared with a preset threshold δd to determine whether it is an access to the same place:

$$\{ \begin{matrix}Dis ( A , B ) \leq δ d & the same place \\ Dis ( A , B ) > δ d & not the same place\end{matrix} . \qquad ( 16 )$$

In an embodiment, this application also provides a system for vehicle place recognition, including a data acquisition and processing module, a descriptor construction module, a threshold calculation module and a place recognition module.

The data acquisition and processing module is configured to preprocess the LiDAR data of the vehicle to obtain the LiDAR point cloud result of the vehicle.

The descriptor construction module is configured to construct the environmental descriptor based on the LiDAR point cloud result.

The threshold calculation module is configured to calculate the threshold of the dynamic filtering strategy based on the type of the LiDAR sensor for collecting the LiDAR data of the vehicle and the measurement environment.

The place recognition module is configured to compare the environmental descriptor with point cloud data in a historical database according to the threshold of the dynamic filtering strategy, to obtain a position information of the vehicle.

Specifically, the present disclosure extracts an intensity information of the non-ground point and a height information of the ground point from the vehicle LiDAR data, and constructs a global environmental descriptor from the bird's eye view. Then based on the obtained environmental descriptor, a coarse-to-fine hierarchical identification is performed to identify the same point from historical visits. During the identification process, the present disclosure accounts for rotational changes during revisits and the use of different sensor models, and is added into map construction through utilizing graph optimization, so as to enhance map consistency. The present disclosure divides the ground point and the non-ground point from LiDAR measurements, and constructs descriptors through fusing the height information of the ground point with the intensity information of the non-ground point, which significantly improves the environmental characterization capability of the descriptors. The present disclosure considers the inherent impact of rotational changes on environmental measurements, and utilizes a unitary invariance of the F-norms to rapidly obtain higher-probability candidates, which improves the accuracy and efficiency of place recognition. The present disclosure considers the angle resolution and measurement range of different LiDAR systems, which proposes the threshold of the dynamic filtering strategy and enhances the generalization capability of the method for various sensor models.

What is claimed is:

1. A method for vehicle place recognition, comprising:
(S1) preprocessing light detection and ranging (LiDAR) data of a vehicle to obtain a LiDAR point cloud result of the vehicle;
(S2) constructing an environmental descriptor based on the LiDAR point cloud result;
(S3) based on a type of a LiDAR sensor for collecting the LiDAR data of the vehicle and a measurement environment, calculating a threshold of a dynamic filtering strategy; and
(S4) according to the threshold of the dynamic filtering strategy, comparing the environmental descriptor with point cloud data in a historical database to obtain a position information of the vehicle;
wherein step of preprocessing the LiDAR data of the vehicle to obtain the LiDAR point cloud result comprises:
downsampling the LiDAR data of the vehicle to generate a downsampled LiDAR data;
filtering out a data within a preset range around the LiDAR sensor for obtaining the LiDAR data from the downsampled LiDAR data;
based on a traveling speed of the vehicle, performing a de-distortion operation on a laser scanning to obtain the LiDAR point cloud result of the vehicle; and
downsampling a point cloud in the LiDAR data of the vehicle using a point cloud voxel filter in a point cloud library (PCL), expressed as:
$$SetInputCloud ( source\_cloud ) ; \qquad ( 1 )$$
$$SetLeafSize ( x\_size , y\_size , z\_size ) ; and \qquad ( 2 )$$
$$Filter ( * dest\_cloud ) ; \qquad ( 3 )$$
wherein source_cloud represents an original point cloud data in the LiDAR data; dest_cloud represents a downsampled point cloud data; and SetlnputCloud(•) SetLeafSize(•) and Filter(•) are functions related to point cloud downsampling in the PCL; and
the step of filtering out the data within the preset range around the LiDAR sensor for obtaining the LiDAR data from the downsampled LiDAR data comprises:
for each laser point in a laser scanning range of the LiDAR sensor, removing laser points whose Euclidean distances are lower than a preset threshold, expressed as:
$$\{ \begin{matrix}\sqrt{( {x}_{i}^{2} + {y}_{i}^{2} )} \leq δ s & filter out \\ \sqrt{( {x}_{i}^{2} + {y}_{i}^{2} )} ≩ δ s & retain\end{matrix} ; \qquad ( 4 )$$
wherein xᵢ and yᵢ respectively represent x-coordinate and y-coordinate of an i-th laser point in a laser scanning frame; and through this step, the laser point within the preset range around the LiDAR sensor are removed.

2. The method of claim 1, further comprising:
removing a distorted data, expressed as:
$$realTime = \frac{1}{{H}_{z}} * arctan ( \frac{y}{x} ) / 360 ; and \qquad ( 5 )$$
$$[ {x}_{i} , {y}_{i} , {z}_{i} ] = [ {x}_{i} , {y}_{i} , {z}_{i} ] * T * realTime + [ {x}_{i} , {y}_{i} , {z}_{i} ] * realTime . \qquad ( 6 )$$
wherein realTime represents a relative time of each laser point within a scan frame, and T represents a motion estimation of the vehicle at a current moment.

3. The method of claim 1, wherein step (S2) comprises:
determining whether each laser point in the LiDAR point cloud result is a ground point or a non-ground point by using g(•), expressed as:
$$g ( x , y , z ) = \{ \begin{matrix}1 & ground point \\ 0 & non - ground point\end{matrix} ; \qquad ( 7 )$$
converting all laser points in the LiDAR point cloud result into a polar coordinate system, expressed as:
$$d = \sqrt{{x}^{2} + {y}^{2}} ; and \qquad ( 8 )$$
$$θ = arctan 2 ( \frac{y}{x} ) ; \qquad ( 9 )$$
wherein d represents a horizontal distance from a laser point to the LiDAR sensor, and θ represents an angle between the laser point and a polar axis;
from a bird's-eye view, dividing a lateral direction into Nr parts based on distance, and dividing a longitudinal direction into Ns parts based on angle;
constructing a Nr*Ns matrix corresponding to Nr*Ns parts;
according to a height information of a ground point and an intensity information of a non-ground point, assigning a value to each unit of the Nr*Ns matrix:
$$Q ( i , j ) = {Z ( i , j )}_{max}^{1 - g} * {I ( i , j )}_{max}^{g} ; \qquad ( 10 )$$
wherein Q(i,j) presents the value of each unit, Z(i,j) represents a maximum height z in a corresponding space, and I(i,j) represents a maximum intensity in the corresponding space; and
assigning values to matrices respectively corresponding to individual spaces to construct a point cloud descriptor.

4. The method of claim 1, further comprising:
denoting an F-norm difference between two descriptors in any two LiDAR measurements as:
$$Ψ ( i , j ) = \frac{abs ( {F}_{i} - {F}_{j} )}{{F}_{i}} ; \qquad ( 11 )$$
wherein Fᵢ and Fⱼ represent F-norms of two descriptors constructed in two separate LiDAR measurements, respectively;
setting a dynamic threshold to be:
$$Φ ( i ) = \frac{abs ( \sqrt{{\sum }_{k = 1}^{n} ( {d}_{k}^{2} + {z}_{k}^{2} )} - \sqrt{{\sum }_{i = 1}^{n} {( {d}_{k} + Δ {ρ}_{k} )}^{2} + {z}_{k}^{2}} )}{\sqrt{{\sum }_{k = 1}^{n} ( {d}_{k}^{2} + {z}_{k}^{2} )}} ; \qquad ( 12 )$$
wherein Δρₖ represents a translation value;
simplifying the dynamic threshold into formula (13) by denoting a maximum Δρ as Δρₘₐₓ and taking z and d as average values of general measurements of the LiDAR sensor:
$$Φ ( i ) = \sqrt{1 + \frac{2 * \overline{d} * {Δρ}_{max} + Δ {ρ}_{max}^{2}}{{\overline{d}}^{2} + {\overline{z}}^{2}}} - 1 ; \qquad ( 13 )$$
comparing with to determine whether two LiDAR measurements are performed at the same position.
